(19) United States
(12) Patent Application Publication
(10) Pub. No.: US 2004/0237089 A1
(43) Pub. Date: Nov. 25, 2004

(54) Separation of data and instruction for improving system performance in a multiple process environment

(76) Inventors: Jin Teik Teh, Los Altos, CA (US); Chang-Lin LIn, San Jose, CA (US)

Correspondence Address: Jason Z. Lin, Supreme Patent Services, Post Office Box 2339, Saratoga, CA, 95070-0339, US

(21) Appl. No.: 10/442,840

(22) Filed: May 20, 2003

(51) Int. Cl. G06F 15/163

(52) U.S. Cl. 719/310

(57) ABSTRACT

A method for separation of data and instructions for speedy message delivery through a software-based multiple processing system is disclosed. In a normal system, the data has to follow the instructions while delivering a message. This causes waste of memory space and time as the data has to be copied from one memory storage to another or from one discrete computing device to another. This invention can improve the performance and storage utilization for processing message containing data and instructions across a multiple process environment.

### FIELD OF THE INVENTION

This invention relates to a method for separating transfer message into data and instructions and, more particularly, to a method for improving system performance by separation of data and instructions in a multiple software process environment.

### BACKGROUND OF THE INVENTION

A virtual hosting, general-purpose data delivery platform is to deliver messages, which consist of data and instructions, to customers. The platform server is the server platform that resides within the infrastructure network. The application server, which is usually a third-party server and resides outside/inside the customer's local area network, is a server that handles all processes and tasks specific to an application or product or service.

The client device connected in the data delivery network is to be resided by both platform client and application client. The platform client is a thin-client that provides generic functionality to transfer messages between the application servers and the application clients. The platform client provides a controller and shell for application clients to provide services, specialized processes or content to users. The platform client routes data and commands between application clients, and between the application servers and the application clients. As for the application client, it is usually a separate module or process that provides a specific task for the client. It can be a module that handles drawing of vector graphics, the playing of MP3 audio files, or other applications.

The platform server provides generic functionality for handling user requests and the transfer of messages between application servers and the application clients. It provides transparent integration between each application server and the clients. It also provides a transparent communication gateway to the clients. It routes data and commands between the application server and the application clients.

In a normal system, data and instructions are contained in the same message. As the message is interpreted and manipulated based on the instructions therein, the data has to follow the instructions. This can cause the waste of memory space and time as the data has to be copied from one memory storage to another or from one discrete computing device to another.

This invention provides a mechanism for the separation of data and instructions for speedy delivery through a software-based multiple processing system. A similar approach has been adopted in micro-processor chips, wherein the instruction and the data portion of an executable statement are separated to speed up the processing speed. However, the present invention is applied in a software processes environment.

### SUMMARY OF THE INVENTION

An object of the present invention, separation of message into data and instruction message, is to improve the system performance in a multiple software process environment.

Another object of the present invention is for improving the storage utilization for processing a data and instruction message across multiple processes.

In order to reach the aforementioned purposes, the present invention adds a conceptual preprocessor in the inlet, and a conceptual post-processor in the outlet of the multiple software process environments. The messages containing data and instructions are received by the pre-processor. The pre-processor splits each message into a data message and an instructions message, if necessary. The instructions message contains a reference ID to the data message. The pre-processor stores the data message into the data buffer where it can be retrieved by the reference ID. The preprocessor sends the instructions message to the first process defined in the instructions message.

The first process inspects the instructions message and performs the necessary functions as determined by the instructions. The first process can access and manipulate the data stored in the data buffer by using the reference ID of the data message in the instructions message.

After the first process has completed its processing of the instructions message, it passes the instructions message along to the next process. The next process does what it needs to do as the previous processes, and so on until the instructions message has reached the last process.

The last process then sends the instructions message to the post-processor. The post-processor retrieves the data message from the data buffer. At this stage, the instructions message and data message may have been modified from its original version. The post-processor combines the instructions and data portions into a new message.

### BRIEF DESCRIPTION OF THE DRAWINGS

Other features and advantages of the present invention will become apparent in the following detailed description of a preferred embodiment with reference to the accompanying drawings, of which:

FIG. 1 is a configuration diagram of the present invention; and

FIG. 2 is the format definition table of the transfer message in the present invention.

### DETAILED DESCRIPTION OF THE INVENTION

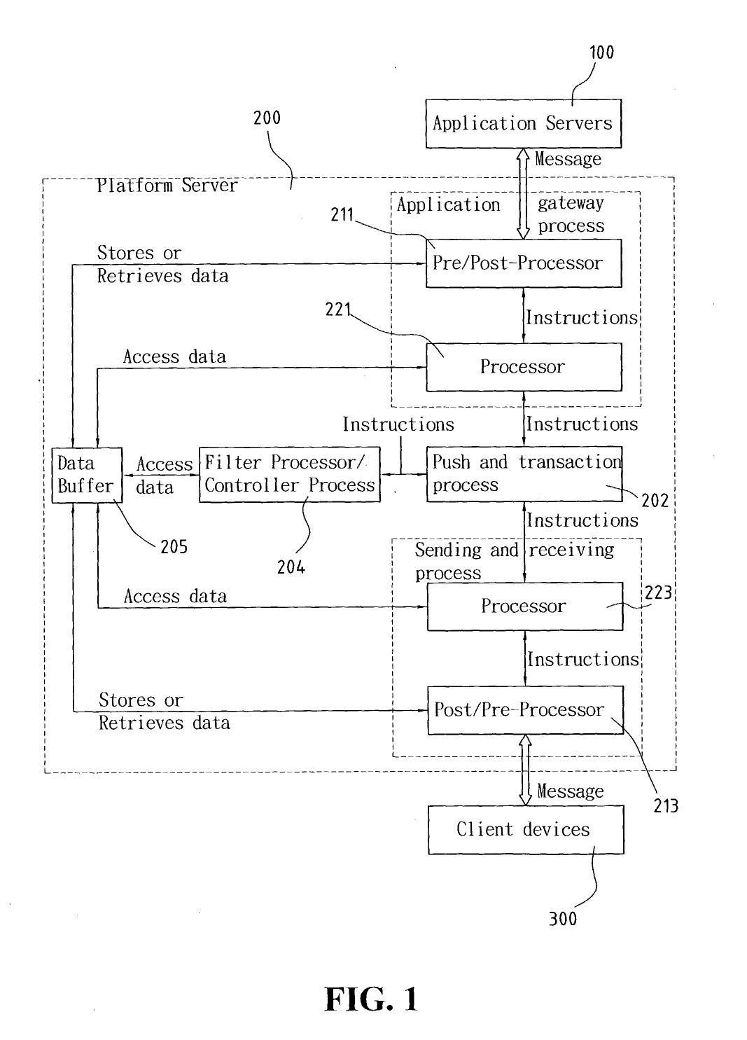

FIG. 1 is a configuration diagram of a preferred embodiment of this invention. In FIG. 1, reference numeral 100 denotes application servers, 200 denotes the platform server, and 300 denotes the client devices. The platform server 200 is a multiple software-based processes environment that includes the application gateway process 201, the push and transaction process 202, the sending and receiving process 203, the filter processes/controller processes 204, and a data buffer 205.

In the platform server 200, messages containing instructions and data can be received by either the application gateway process 201 or the sending and receiving process 203.

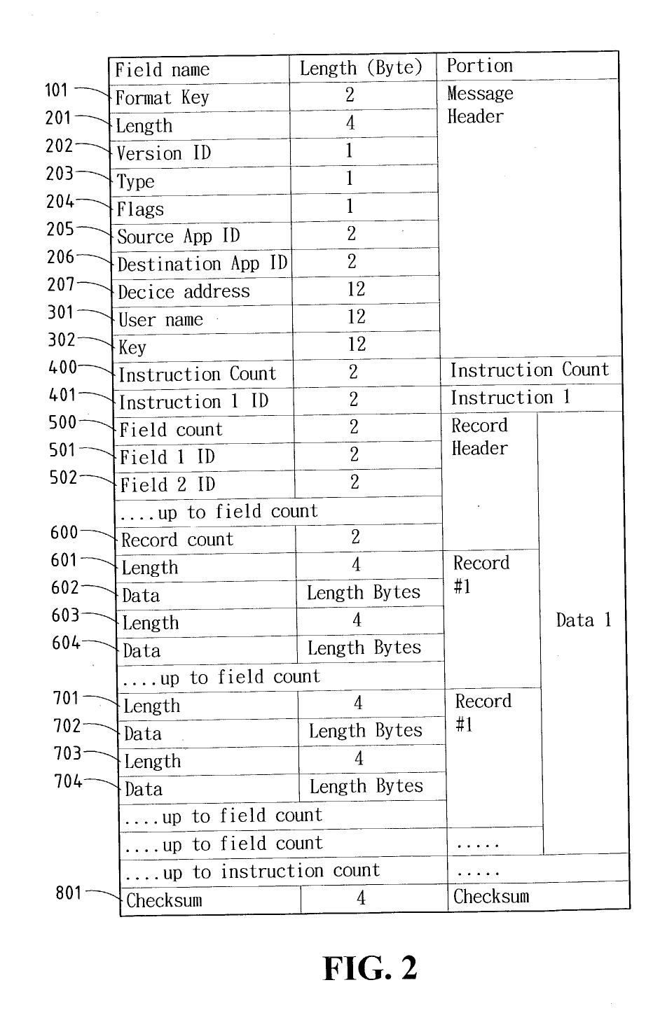

The format of the transfer message in the preferred embodiment of this invention can be described by a format definition table as shown in FIG. 2. Referring to FIG. 2, at the right part of the format definition table, a message can be briefly divided into four portions, including message header (49 bytes in total), instruction count (2 bytes), each instruction and its relative data (2 bytes for instruction ID, and variable length for the data parts), and checksum (4 bytes). The minimum size of a message is 53 bytes, with only message header and checksum.

Referring to FIG. 2 again, each message field and its length can be seen from the format definition table, and each message field will be explained in the follows:

Message Header

(1). Format key 101: The format key precedes every message. It consists of 2 bytes containing an ASCII ‘H’ in the first byte and an ASCII ‘M’ in the second byte. They are used only for distinguishing the transfer message is accepted in the platform server of this invention.

(2). Message length 201: It describes the amount of data in bytes of this transfer message, excluding format key field 101 and this message length field 201. The message length field 201 is 4 bytes in length. The minimum value of the message length field 201 is 47, which includes the message header, excluding the format key field 101 and the message length field 201, and the checksum field 801 at the end. The maximum value of the message length field 201 is defined to be 4 Giga. The value this message length field 201 is the length of instruction-data pairs plus 47.

(3). Version ID 202: The version of this message format.

(4). Type 203: The type of data, bit0 indicates encrypted or not, bit1 indicates compressed or not, bit2 to bit4 indicate the priority levels, and bit5 to bit7 indicate message types.

(5). Flags 204: This field contains flags that are used to determine the data type in data section (3 bits), one way or two way message (1 bit), and filtering or non-filtering (1 bit) etc. The data type in data section of message is defined as: 000˜application specific data, 001˜data record ID in data buffer, 010˜broadcasting data, etc. This flags field 204 and type field 203, are sometimes called meta-information of a message data.

(6). Source application ID 205: The unique source application ID describing the ID of the application that sent the message. If the message was sent by the application server, it is the application server's ID.

(7). Destination application ID 206: The unique ID describing the destination application. If the message was sent to an application server, it is the application server's ID. If it was sent to a client, it is the client's ID.

(8). Device address 207: The device address is a 12-byte character representation of the device address such as phone number.

(9). User name 301: 12 bytes, for the user name of the sender or recipient.

(10). Key 302: 12 bytes, the encoded key consisting of the user's password and a shared key. The key is not required when the message is sent to the client. It is required for message sent from the client to the server. Encrypted keys will be in binary form.

Instruction Count

(1). Instruction count 400: This 2-byte field provides the number of instructions described in this message.

Each Instruction and its Related Data

(1). Instruction 1 ID 401: The ID of the first instruction in this message. In general, the instruction ID is determined by the source and destination application. The instruction ID must be consistent and shared between the sender application and the destination application. Some examples of instructions are “Get”, “Send”, “Add”, “Delete”, “Replace”, and “Cancel”.

(2). Data 1: The data related to the instruction 1. The data is organized into Record header, Record #1, Record #2, and so on. Record header consists of Field count 500, Field 1 ID 501, Field 2 ID 502, and so on, and finally the Record count 600. Record #1 consists of each field's length and actual data, of this Record #1, that is, from Length 601 to Data 604, and so on. Record #2 consists of each field's length and actual data, of this Record #2, that is, from Length 701 to Data 704, and so on.

Checksum

(1). Checksum 801: A CRC-32 checksum of the entire message, excluding last 4 bytes, is calculated and compared with this 4-byte checksum. This is to ensure that the entire message was received. If the checksum does not match, or if the message was truncated, the message should be discarded.

Having described the message format in the above, turning now to FIG. 1 for the description of the processing flow of the separation of data and instructions, of the preferred embodiment of this invention.

Referring to FIG. 1, when the message is received by the application gateway process 201 from an application server 100, the pre-processor 211 splits the message into an instructions part and a data part. The data is assigned a data buffer ID and is stored in the data buffer 205. The data buffer ID is attached to the instructions part. The instructions part with the data buffer ID is called the instructions message.

The instructions message is sent to the first processor 221 for processing. The processor 221 can access the data in the data buffer 205 as needed, using the data buffer ID in the instructions message. The instructions message proceeds to the push and transaction process 202.

The push and transaction process 202 routes the instructions message based on the instructions and meta-information in the message. It can route the message to a filter process or a controller process 204 to perform more actions on the data in the data buffer 205.

A filter process 204 could transform the data into a different format if requested by the instructions in the instructions message. Once the filter process or controller process 204 has completed their actions on the data, the instructions message is sent back to the push and transaction process 202.

The push and transaction process 202 routes the message based on other meta-information stored in the message. It can be sent to the sending and receiving process 203 for sending to an end-user.

The sending and receiving process 303 receives the instructions message. Additional processing can be done here. Finally, the post-processor 213 retrieves the data from data buffer 205, appends it to the instructions message and sends it to the end-user.

When a message, containing instructions and data, is received by the sending and receiving process 203 from a client device 300, it utilizes the same algorithm used when messages are received by the application gateway process 201 from an application server 100.

The sending and receiving process 203 receives the instructions and data message. The pre-processor 213 splits the message into instructions and data. A data buffer ID is created and the data portion is sent to the data buffer 205. The data buffer ID is appended to the instructions portion and sent as an instructions message to the first processor 223 to process the instructions. The processor can access the data in the data buffer 205 using the data buffer ID.

When processing in the sending and receiving process 203 is completed, the instructions message is sent to the push and transaction process 202 for further processing. The push and transaction process 202 routes the message based on the instruction in the instructions message. The message can be routes to a filter process/controller process 204 or to the application gateway process 201.

If the message is routed to the filter process/controller process 204, those processes can manipulate or modify the data in the data buffer 205.

If the message is routed to the application gateway process 201, the post-processor 211 retrieves the data from the data buffer 205. It replaces the data buffer ID in the instructions message with the data and sends the reconstructed data and instructions message to the application servers 100.

Having explained a preferred embodiment above, it is to be understood that the invention is not to be limited to the disclosed embodiment, but on the contrary, is intended to cover various modifications and equivalent arrangement included within the spirit and scope of the appended claims.

What is claimed is:

1. In a multiple process system having a data buffer, a method for transferring message containing the data and instructions from a sender to recipients, comprising the steps of:
(1) pre-processing: receiving the message from said sender and splitting said message into a data message and an instruction message containing a reference ID to said data message, storing said data message into said data buffer where it can be retrieved by using said reference ID;
(2) sending said instructions message to a first process as defined in said instruction message;
(3) processing in the first process: inspecting said instructions message and performing the necessary functions as determined by said instructions, accessing and manipulating said data stored in said data buffer by using said reference ID if the functions need to, and then passing said instructions message to an intermediate process as defined in said instructions message;
(4) processing in the intermediate process as said first process does, and so on until it has reached the last process, then passing said instructions message for post-processing;
(5) post-processing: retrieving said data message from said data buffer, combining said instructions and data portions into a new message and sending it to the recipients as determined by the message.

2. The method as claimed in claim 1, wherein said message can be divided into portions of: message header, instruction count, each instruction and its related data, and checksum; in which said message header stores the general information of said message, instruction count stores the number of instructions in said message, and checksum stores the number to ensure the entire message was received.

3. The method as claimed in claim 1, wherein said message sender is a third-party application server, and the message recipients are the client devices.

4. The method as claimed in claim 1, wherein the message sender is a client device, and the message recipients are the third-party application servers.

5. A multiple-processes system for transferring message containing data and instructions from sender to recipients, having a data buffer, further comprising:
a pre-processor receiving the message from the sender and splitting the message into a data message and an instructions message containing a reference ID to the data message, storing the data message into said data buffer where it can be retrieved by using said reference ID, and sending the instructions message to a first process means as defined in said instructions message;
a first process as defined in the instructions message then inspecting said instructions message and performing the necessary functions as determined by the instructions, access and manipulate the data stored in said data buffer by using said reference ID if the functions need to, and then passing said instructions message to an intermediate process as defined in said instructions message;
an intermediate process as defined in said instructions message then executing as the first process means does, and so on until it has reached the last process means, then passing said instructions message for post-processing; and
a post-processor which retrieving said data message from said data buffer, combining said instructions and said data portions into a new message and send it to the recipients as determined by the message.

6. The multiple-processes system as claimed in claim 5, wherein said message can be divided into portions of: message header, instruction count, each instruction and its related data, and checksum; in which said message header stores the general information of the message, instruction count stores the number of instructions in said message, and checksum stores the number to ensure the entire message was received.

7. The multiple-processes system as claimed in claim 5, wherein said message sender is a third-party application server, and the message recipients are the client devices.

8. The multiple-processes system as claimed in claim 5, wherein said message sender is a client device, and the message recipients are the third-party application servers.

9. An apparatus for separating instruction and data portions of a message for speedy message processing, said apparatus comprising:
a memory for storing a program, and
a processor responsive to said program to receive a message from a sender in a software processes environment, split said message into a data message and an instruction message, store the data message into a data buffer, and send the instruction message to a first software process for processing.

10. The apparatus as claimed in claim 9, wherein said memory comprises a hard disk drive.
